(19) United States
(12) Patent Application Publication
(10) Pub. No.: US 2004/0267720 A1
(43) Pub. Date: Dec. 30, 2004

(54) Query system for structured multimedia content retrieval

(76) Inventors: Peiya Liu, East Brunswick, NJ (US); Amit Chakraborty, Cranbury, NJ (US); Liang H. Hsu, West Windsor, NJ (US)

Correspondence Address: Siemens Corporation, Intellectual Property Department, 170 Wood Avenue South, Iselin, NJ, 08830, US

(21) Appl. No.: 10/609,257

(22) Filed: Jun. 27, 2003

(51) Int. Cl. G06F 7/00

(52) U.S. Cl. 707/3

(57) ABSTRACT

A query system for structured multimedia content retrieval comprises a query language based on logic formalism for content retrieval. The language includes query constructs and formalisms for specifying different aspects of XML documents and the constructs and formalisms are particularly adapted for spatial, temporal and visual datatypes. Certain critical specification issues in MPEG-7 XML queries are identified. An XML query language with multimedia query constructs is described which is based on a logic formalism, called path predicate calculus. In this path predicate calculus, the atomic logic formulas are element predicates rather than relation predicates in relational calculus. In this path calculus query language, queries in this calculus are equivalent to finding all proofs to existential closure of logical assertions in the form of path predicates that the tree document elements must satisfy. Spatial, temporal and visual datatypes and relationships can also be described in this formalism for content retrieval.

The present invention relates generally to computer query systems and relates more specifically to computer query systems for structured multimedia content retrieval.

### BACKGROUND OF THE INVENTION

Query languages are programming languages designed to facilitate specifying the information to be retrieved from, for example, a database or other source. The extensible markup language XML is a standard way of tagging data so that it can be read and interpreted by various Web browsers and, various software servers and users without regard to how it was created.

### BRIEF SUMMARY OF THE INVENTION

Many query languages are currently being proposed for specifying XML document retrievals.

As is herein recognized, the expressive power and usefulness of these query languages is really based on their embedded formalisms and intended XML document applications. The MPEG-7 multimedia standard uses XML Schema:Datatypes for multimedia content descriptions and, as is herein recognized, has posed an interesting challenge to XML query language design for XML document retrievals. Most XML query language proposals have limitations in specifying queries for this type of XML documents.

In accordance with an aspect of the invention, a query system for structured multimedia content retrieval includes a query language having query constructs and formalisms for specifying characteristics of extensible markup language (XML) documents for retrieval; and wherein the characteristics include spatial, temporal, and visual datatypes.

In accordance with another aspect of the invention, the query language includes: apparatus for resolving intensional data and relationships arising from any of: (a) XML datatype mechanism; (b) irregular XML structures; and (c) co-occurrence constraints.

In accordance with another aspect of the invention, wherein the apparatus for resolving comprises a logic formalism for supporting queries on XML documents with any of: (A) intensional data and relationships; (B) irregular document structures; and (C) and co-occurrence constraints.

In accordance with another aspect of the invention, a query system for structured multimedia content retrieval includes a query language based on logic formalism for content retrieval, the logic formalism being hereinafter referred to as Path Predicate Calculus and being utilized for logic-based queries and manipulations; the Path Predicate Calculus including atomic logic formulas, the atomic logic formulas being element predicates in a relational calculus and comprising element predicates and path predicates, for asserting logical truth statements about document elements in a document tree; apparatus for identifying given specifications of multimedia XML documents in MPEG-7 XML query specifications; and apparatus for applying the logic formalism for processing the given specifications for specifying spatial and temporal relationships pertaining to the XML documents to support MPEG-7 XML document retrieval and modification multimedia XML documents.

In accordance with another aspect of the invention, a method for structured multimedia content retrieval comprises utilizing a query language based on logic formalism for content retrieval, the logic formalism including atomic logic formulas, the atomic logic formulas being element predicates in a relational calculus; identifying given specifications of multimedia XML documents in MPEG-7 XML query specifications; and applying the logic formalism for processing the given specifications for specifying spatial and temporal relationships pertaining to the XML documents to support MPEG-7 XML document retrieval and modification of multimedia XML documents.

In accordance with another aspect of the invention, a query system for structured multimedia content retrieval comprises a query language based on logic formalism for content retrieval. The language includes query constructs and formalisms for specifying different aspects of XML documents and the constructs and formalisms are particularly adapted for spatial, temporal and visual datatypes. Certain critical specification issues in MPEG-7 XML queries are identified. An XML query language with multimedia query constructs is described which is based on a logic formalism, called path predicate calculus. In this path predicate calculus, the atomic logic formulas are element predicates rather than relation predicates in relational calculus. In this path calculus query language, queries in this calculus are equivalent to finding all proofs to existential closure of logical assertions in the form of path predicates that the tree document elements must satisfy. Spatial, temporal and visual datatypes and relationships can also be described in this formalism for content retrieval.

### BRIEF DESCRIPTION OF THE SOLE FIGURE OF THE DRAWING

The invention will be more fully understood from the detailed description which follows, in conjunction with the drawing, in which the SOLE FIGURE,

FIG. 1 illustrates an industrial inspection video which as an MPEG-7 document comprising an AudioVisual content, helpful to an understanding of the present invention.

### DETAILED DESCRIPTION OF THE INVENTION

The compression standard known as MPEG-7 is an emergent ISO/IEC standard and is formally named Multimedia Content Description Interface. Unlike the previous MPEG compression standards MPEG-1, MPEG-2 and MPEG-4, the MPEG-7 compression standard aims to create a standard for describing the multimedia content to enable the integration of production, distribution and content access paradigm. Further information on previous MPEG compression standards may be found, for example, on the World Wide Web at MPEG Web Site: http://www.cselt.it/mpeg/standards.htm.

It is herein recognized that an important component of such a query system is the query language utilized therein. An object of the present invention is to provide a query system comprising a computer query language and, more specifically, a computer query language for XML documents.

A query system for structured multimedia content retrieval comprises a query language based on logic formalism for multimedia content retrieval. The language includes query constructs and formalisms for specifying different aspects of XML documents and the constructs and formalisms are particularly adapted for spatial, temporal and visual datatypes. Certain critical specification issues in MPEG-7 XML queries are identified. An XML query language with multimedia query constructs is described which is based on a logic formalism, called path predicate calculus. In this path predicate calculus, the atomic logic formulas are element predicates rather than relation predicates in relational calculus. In this path calculus query language, queries in this calculus are equivalent to finding all proofs to existential closure of logical assertions in the form of path predicates that the tree document elements must satisfy. Spatial, temporal and visual datatypes and relationships can also be described in this formalism for content retrieval.

The MPEG-7 standard uses XML Schema to describe multimedia objects such as video, audio images, etc. as spatial, temporal or visual XML datatypes. These types of multimedia XML documents may include descriptions about both static media, such as, for example, text, graphics, drawings, images, etc., as well as spatio-temporal media, such as, for example, video, audio, animation, etc. The content can be further organized into three major document structures: hierarchical, hyperlinked, and temporal/spatial structures. MPEG-7 raises many interesting challenges in the design of XML query languages to cover different aspects of XML documents.

A number of document query languages have been proposed for document retrievals, such as, for example, ISO 10179:1996 Information Technology—Processing Languages—Document Style Semantics and Specification Language (DSSSL) and the recent XQuery: An XML Query Language: W3C Working Draft 2 May 2003. The following are also of interest: ISO/IEC 10744:1997 Hypermedia/Time-based Structuring Language (HyTime), Second Edition; Synchronized Multimedia Integration Language (SMIL) 1.0 Specification, W3C Recommendations 15 Jun. 1998; and SQL Standardization Projects: http://wwwjcc.com/SQLPages/jccs_sql.htm (SQL Standard Reference Page)

However, it is herein recognized that these languages cannot adequately support MPEG-7 XML document queries due to limited expressive power about XML datatypes for specifying intensional multimedia data and relationships inside XML documents, as will be further explained. This has limited the usage of query languages in XML document retrievals. An ideal XML query language should support different aspects of XML structures and datatypes.

The present inventors have identified several critical issues in MPEG-7 XML query specifications. In particular, they are intensional data and relationships specifications, document addressing specifications, and co-occurrence constraints specifications.

In accordance with an aspect of the invention, certain critical specification issues in MPEG-7 XML queries are identified. An XML query language, mmdocQuery with multimedia query constructs is herein disclosed. mmdocQuery is based on a logic formalism, called path predicate calculus. In this path predicate calculus, the atomic logic formulas are element predicates rather than relation predicates in relational calculus. In this path calculus query language, queries in this calculus are equivalent to finding all proofs to existential closure of logical assertions in the form of path predicates that the tree document elements must satisfy. Spatial, temporal and visual datatypes and relationships can also be described in this formalism for content retrieval.

In accordance with an aspect of the present invention, these issues are tackled by the use of a logic formalism, herein referred to as Path Predicate Calculus with multimedia query constructs in the XML query language in accordance with the present invention, mmdocQuery, for specifying spatial and temporal relationships to support MPEG-7 XML document retrieval and modification.

This approach, in accordance with the present invention offers several advantages. First, these critical issues are tackled within the same logic framework—in the past, two formalisms have typically been used for describing query languages in relational models; see, for example, H.

Gallaire, J. Minker and J. M. Nicolas, “An Overview and Introduction to Logic and Database”, in Logic and Database, (H. Gallaire and J. Minker ed), 1978. These formalisms are:

(1) algebraic formalism, called relational algebra; and

(2) logic formalism, called relational calculus, including (a) tuple relational calculus and (b) domain relational calculus. Regarding (a), see for example E. F. Codd “Relational completeness of data base sub languages”, in Data base Systems (R. Rustin, ed) Prentice-Hall, Englewood Cliff, N.J., 1972; regarding (b), see for example A. Piottee. “High Level Data Base Query Language”, in Logic and Database, (H. Gallaire and J. Minker ed), 1978.

However, due to underlying data models being different from the document model, these formalisms for relational query languages could not be directly used as formalisms for XML query languages. Queries in this formalism are equivalent to finding all proofs to existential closure of logical assertions that document elements must satisfy. In Path Predicate Calculus, the atomic logic formulae are element predicates for asserting logic statements about document elements in a document tree.

As has been recognized by the present inventors, many spatial/temporal/visual operations can be expressed in such a logic formalism. The relational calculus is a special case of this logic form when applying to “flat” data-oriented documents and element predicates are degenerated into relational predicates as in relational models. Furthermore, it provides “non-proceduribility” of document queries. Historically, calculus-based relational query languages are more prevalent than algebraic languages due to declarative characteristics of logic formalism. The algebraic approach, taken by W3C Query Working Group often needs to explicitly describe the order of operations on underlying data models to express the queries. See XQuery: An XML Query Language: W3C Working Draft 2 May 2003; the above-cited publication by H. Gallaire et al.

The logic formalism provides a higher-level notion to express queries since it is based on logical computation in query processing to finding all proofs for logic query statements. More particularly, it is easier to express thereby co-occurrence XML element constraints and is integrated with query constructs for specifying multimedia object relationships in querying multimedia content descriptions. The path predicate approach can also directly work on XML document model rather than a specific data model of documents.

In describing an MPEG-7 XML Query Specification, a typical MPEG-7 Document will be first described followed by a description of the search strategy. With regard to MPEG-7 XML Documents, following is an example of a typical Mpeg-7 document:

<Mpeg7Main name=“turbinevideo” version=“1.0” copyright=“Siemens”>

<ContentDescription xsi:type=“ContentEntityDescriptionType”>

<AudioVisualContent xsi:type=“VideoType”>
<Video id=“TurbineVS”>

<TextAnnotation>

<FreeTextAnnotation xml:lang=“en-us”>Turbine Inspection
</FreeTextAnnotation>

</TextAnnotation>
<SegmentDecomposition gap=“false” overlap=“fasle”

decompositionType=“spatioTemporal”>

<!-- first Scene “Overview” -->
<Segment xsi:type=“MovingRegionType” id=“OverviewScene”>
... </Segment>
<!-- The Seond Scene “Burner” -->
<Segment xsi:type=“MovingRegionType” id=“BurnerScene”>

<TextAnnotation>

<FreeTextAnnotation xml:lang=“en-us”>Burner
</FreeTextAnnotation>

</TextAnnotation>
<SegmentDecomposition gap=“false” overlap=“false”

decompositionType=“spatioTemporal”>

<!-- The first VideoObject -->
<Segment xsi:type=“MovingRegionType” id=“MR001”>

<MediaTime> ... </MediaTime>
<SpatioTemporalLocator>

<MediaTime> ...</MediaTime>
<ParameterTrajectory MotionModel=“0”>

<MediaTime>...</MediaTime>
<RegionLocator>

<Poly><Coords dim=“4 2”>

5 25 10 20 15 15 10 10</Coords></Poly>

</RegionLocator>
<Parameters KeyPointNum=“25”>

<WholeInterval>

<MediaIncrDuration TimeUnit=“P1S”>300
</MediaIncrDuration>

</WholeInterval>
<InterpolatedValue>

<!-- Total 25 interpolated points -->
<KeyValue Type=“startPoint”

dimension=“2”>

5.0
</KeyValue>
<KeyValue ... > ... </KeyValue>
...

</InterpolatedValue>
<InterpolatedValue>

<!-- Total 25 interpolated points -->
<KeyValue Type=“startPoint”

dimension=“2”>

25.0
</KeyValue>
<KeyValue ... > ... </KeyValue>
...

</InterpolatedValue>

</Parameters>

</ParameterTrajectory>
<ParameterTrajectory MotionModel=“0”>...
</ParameterTrajectory>
...

</SpatioTemporalLocator>

</Segment>
<!-- The Second VideoObject -->
<Segment xsi:type=“MovinglRegionType” id=“MR002”>

<MediaTime> ... </MediaTime>
<SpatioTemporalLocator>... </SpatioTemporalLocator>

</Segment>
...

</SegmentDecomposition>

<MediaTime>

<MediaTimePoint>...</MediaTimePoint>
<MediaDuration>...</MediaDuration>

</MediaTime>

</Segment>
<!-- The “Opener” Scene -->
<Segment xsi:type=“MovingRegionType” id=“OpenerScene”>
... </Segment>

<!-- The last Scene -->
<Segment .. > ... </Segment>

</SegmentDecomposition>
<GofGopColor> ... </GofGopColor>

</Video>

</AudioVisualContent>

<ContentDescription>

</Mpeg7Main>

This MPEG-7 document is related to an industrial turbine inspection video and it comprises an AudioVisualContent of type “VideoType” named “TurbineVideo”. The video is segmented into scenes and the scenes are described by using the “SegmentDecomposition” tag with the decomposition type “SpatioTemporal”. Each segment or scene can have several objects of interest and they are described here as well. In particular, consider the second segment, which has an id “BumerScene” and is of type “MovingRegionType”. We use the “MovingRegionType” tag because there are multiple objects that move over time. The detailed descriptions are as follows.

The video segments (scenes) in this example can be further broken up using the same “SegmentDecomposition” tag which is again of the type “SpatioTemporal”. It is noted that the first object has an id “MR001”, and that it moves over time, the trajectory being given here. The tag “MediaTime” provides the duration of the object. The location of the object is defined temporally using the tag “ParameterTrajectory”. At the first frame or instance where the object first appears, the location is given by a 4×2 matrix defining the four coordinates of the object boundary. Any number of coordinates can be used to define the boundary. The complete interval, in this example, defined using “Wholelnterval” tag, consists of 300 secs. The base time unit is 1 sec (P1S). There are 25 node points which determine the “KeyPointNum”. The “InterpolatedValue” tag is used to define the corresponding coordinates of the object of interest at each of these nodes. Each KeyValue gives the coordinate location for a single vertex. This is done for all four vertices that constitute the boundary in this exemplary case. Since the value of attribute “MotionModel” is 0, it indicates a linear model. For frames that lie within these nodes, a simple linear interpolation is used to determine the actual location on that frame. The rest of the example follows the above format to describe other objects and scenes in the video.

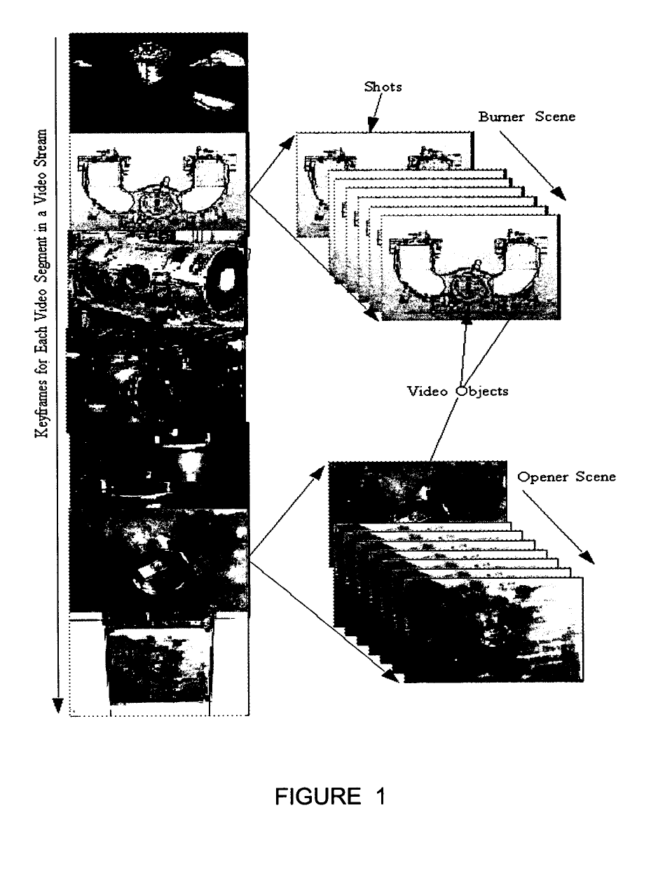

FIG. 1 shows an industrial inspection video, illustrating an example of an MPEG-7 document comprising an AudioVisual content.

In accordance with the principles of the present invention, a tool is disclosed, based on the scene change technique, to generate such a description from a video, as follows. At first, the video is broken down temporally into scenes or shots using scene change detection algorithms that can detect both abrupt as well as gradual changes. Next, the users identify objects of interest within these scenes and outline them. These are then tracked over time in a semi-automatic way. Wherever there is a significant motion change and a linear mode is inadequate, a node point is created. To make things simpler as described in the above example, one can also divide the interval into equal segments. At these boundaries, node points are created and the object outline is described.

Next, the specification of multimedia objects as temporal, audio, and visual datatypes is considered. Multimedia objects can be described as spatial, temporal and visual datatypes by using abstract datatype techniques (ADT). The composite datatypes can be constructed from more primitive ones. These datatypes can be formalized as XML element datatypes within W3C XML Schema framework, particularly the datatype part. See XML Schema Part 1: Structures, W3C Recommendation 2 May 2001; and XML Schema Part 2: Datatypes: W3C Recommendation 2 May 2001.

The relationships of multimedia objects are often derived from element datatypes rather than from element hierarchical relationships. The relationships can be even predefined as another complex datatypes for multimedia XML documents.

At the 51^{st} MPEG meeting in March 2000, the MPEG committee has decided to adopt XML Schema Language as MPEG-7 Description Definition Language (DDL) for describing multimedia content. Since then, a comprehensive set of audio and visual datatypes is being developed based on XML datatype mechanisms. The main components of the MPEG-7 standard are: Descriptors (Ds) for describing audio and visual features, and Description Schemes(DSs) for describing the structure and semantics of the relationships between components. The components can be either Ds or DSs. There is also a description definition language for allowing the creation of a new D or DS and for allowing extension of existing Ds or DSs.

MPEG-7 datatype hierarchy can be viewed as follows:

1. The base level datatypes are: Mpeg7Type, basic datatypes, reference datatypes, unique identifier datatypes, and time datatypes. Mpeg7Type provides the main basic abstract type of MPEG-7 type hierarchy. From Mpeg7Type are derived: DSType (Description Scheme Type) and DType (Descriptor Type). From DSType are derived: SegmentType, RelationType, GraphType, VisualDSType and AudioDSType. From DType are derived: VisualDType and AudioDType. From SegmentType are derived: StillRegionType, VideoSegmentType, MovingRegionType, AudioSegmentType AudioVisualSegmentType, and SegmentDecompositionType. Some of the temporal, audio and visual datatypes are described as follows.

2. MPEG-7 visual datatypes are used to specify visual properties of multimedia objects such as spatial, color, texture, motion, location, etc. All visual datatypes are derived from VisualDType. The spatial datatypes are used to specify geometric data such as points, polylines or regions, etc. The composite visual datatypes can be constructed from these primitives. Examples are: RegionShapeType, ConturShapeType, RegionLocatorType, etc. In the present exemplary embodiment, RegionLocatorType is used, which comprises points in pairs of coords matrix datatype for describing video objects.

3. MPEG-7 audio datatypes are used to specify audio content. Examples are SoundEffectCategoryType, SilenceType, etc. All audio datatypes are derived from AudioDType.

MPEG-7 temporal, audio and visual datatypes can be further composed into more complex MPEG-7 datatypes by using XML datatype definition mechanism from predefined MPEG-7 Ds, or predefined MPEG-7 DSs. The commonly used DSs for composing the content are: SegmentDecomposition DS, Segment DS (e.g. MovingRegion DS, StillRegion DS, etc), Graph DS and Relation DS. Each DS or D itself is a MPEG-7 datatype. For example, MPEG-7 ParameterTrajectory datatype, SpatioTemporalLocator DS and MovingRegion DS are all spatio-temporal composite datatypes, called ParameterTrajectoryType, SpatioTemporalLocatorType and MovingRegionType, respectively, for specifying spatial data changing over time. These spatio-temporal datatypes are constructed from primitive temporal datatypes (e.g., MediaTime) with spatial datatypes (e.g., RegionLocatorType) or previously defined spatio-temporal datatypes. In addition to content description DSs in MPEG-7, there are many other DSs that facilitate content navigation, content organization, content management, and user interaction. MPEG-7 DSs are used to support varieties of multimedia content retrievals such as semantics-based retrievals, structured-based retrievals, model-based retrievals, and navigation/browsing (e.g., content summary).

In the foregoing video example, we use one top-level SegmentDecomposition DS comprising many first-level Segment DSs with MovingRegion Type. Each Segment DS corresponds to a scene. The details are given in the second scene or Segment DS. This burner scene is further composed by a second-level SegmentDecomposition DS which comprises many Segement DSs corresponding to video objects. Each video object is described by elements MediaTime, SpatioTemporalLocator and ParameterTrajectory as a composite spatio-temporal datatype. Since MPEG-7 content descriptions heavily depend on the XML datatypes, MPEG-7 XML content access and relationships expression require an expressive XML query language with multimedia datatypes support for media-rich XML content retrievals.

A number of query specification issues which arise for MPEG-7 XML are herein recognized.

MPEG-7 XML documents pose an interesting challenge for XML query language design for covering an important aspect of XML structure and datatype usage. In the following, three crucial query specification issues in MPEG-7 XML document retrievals are addressed.

1.0 Intensional Data and Relationship Specifications: Extensional data and relationships are those data and relationships that are explicitly stored in XML documents. Intensional data and relationships are those that are computed or deduced from extensional data and relationships in XML documents. Many relationships of multimedia objects in MPEG-7 documents are derived from stored content descriptions based on element datatypes or DS schemes rather than from XML element hierarchical relationships. Thus, the capability of expressing the relationships in query language constructs is crucial for MPEG-7 query specifications. Examples of the relationships are point-inside, region-overlap, etc. In addition, many items of spatial and temporal data are represented in an implicit manner inside MPEG-7 XML documents unlike data in relational databases. For example, an instance of MediaTime element in MPEG-7 means a time interval. It is important to express those implicit MediaTimePoints in that interval in query language since identification of multimedia objects may depend on a particular MediaTimePoint.

2.0 Document Addressing Specifications: MPEG-7 XML documents often contain irregular document structures. For instance, a Segment tag that can be inside another Segment tag in MPEG-7 XML documents. MPEG-7 content structures are based on their own datatypes and description schemes (DSs) rather than on XML element hierarchy. MPEG-7 XML documents normally are not data-centered documents which are a collection of almost identical structures. A full document addressing query construct is needed to precisely specify the desired document locations in recursive or contextual XML structures for retrieving information.

3.0 Co-occurrence Constraints Specifications: The multimedia object descriptions have temporal and spatial synchronization constraints in nature. Thus MPEG-7 XML document elements normally have co-occurrence constraints, e.g. if one XML element for a multimedia object description has attribute A in certain spatial location, it must have the same attribute A in another location. Another example is: two multimedia objects appear inside the same spatial region at the same time.

In accordance with the principles of the present invention, an XML Query language mmdocQuery takes into consideration the foregoing issues and concerns. This language embeds within it a logic formalism Path Predicate Calculus to specify queries. This path predicate calculus can adequately support the co-occurrence constraints and document addressing specifications for querying XML documents. To support intensional data and relationships specifications in this logical formalism, certain stereotypical logic operators are incorporated for asserting multimedia object relationships in this query language. Examples of the multimedia logic operators are, OVERLAP(element1: RegionLocatorType, element2: RegionLocatorType), TRAJECTORY(element1: MovingRegionType, element2 MediaTimePoint), etc. Another logic operator MEMBERP is also included for asserting intensional data such as MediaTimePoint in the language constructs.

The following illustrates mmdocQuery for specifying MPEG-7 XML document queries. An example of query is in the form of “finding all video object ids and show up time over a particular area”.

| | |
|---|---|
| GENERATE | <List> |

<Videoobject>%objectid</videoobject>
<ShowUpTime>%t</ShowUpTime>

| | |
|---|---|
| | </List> |
| PATTERN | {“MR”[0-9][0-9][0-9]/%objectid} |
| | (<region> ... </region>/%focusarea} |
| FROM | mpeg7video.xml |
| CONTEXT | ((<Segment> WITH xsi:type=“MovingRegionType” |

id=%objectid AT %movingregion )

```
  CONTAINING
  (<SpatioTemporalLocator> DIRECTLY
CONTAINING
```

(<MediaTime> AT %x)))

AND MEMBERP(%t %x)
AND OVERLAP(TRAJECTORY(%movingregion %t)
%focusarea))

In mmdocQuery, there are four clauses: OPERATION clause (either GENERATE, INSERT, DELETE, or UPDATE) is used to describe the logic conclusions in the form of allowable element predicates and path predicates. The present embodiment in accordance with the principles of the invention focuses on retrieval operation clause by using keyword GENERATE for MPEG-7 XML queries. GENERATE clause is similar to SELECT in SQL, but works for XML documents. PATTERN clause is used to describe the domain constraints of free logical variables including tag, attribute, content, address and datatype, by using regular expressions. FROM clause is used to describe source documents for querying. CONTEXT clause is used to describe logic assertions about document elements in allowable logic formulas in path predicate calculus. FROM and CONTEXT clauses are paired together and there could be multiple pairs for describing multiple sources. The logic variables are indicated by “%” such as “% objectid”.

Queries in mmdocQuery are equivalent to finding all proofs to existential closure of logical assertions.

In this example, the path formula

(<Segment>WITHxsi:type=“MovingRegionType”<MediaTime>AT % x)

in CONTEXT clause asserts that element Segment with id equal to % objectid contains element SpatioTemporalLocator of which the video objects are located during MediaTime % x.

In general, (<% t>WITH attribute_{—}1=% x 1, . . . , attribute_n=% x n AT % a CONTAINING % c) is an English-like notation for element predicate E(x1, x2, . . . , xn, c, t, a) which stands for a logic assertion that element “t” at address “a” contains “c” with attributes x1, x2, . . . ,xn in a document tree. A path logic formula is a composition of element predicates by Xpath axis-operators such as DIRECTLY CONTAINING, etc. See XML Path Language (XPath) Version 1.0, W3C Recommendations 16 Nov. 1999. Note that here, compared with context variables and functional forms in XPath, we use a logic form of XPath axis-operators with logical variables in the path formula for asserting logical truths about document elements. The domain of logical variable % objectid is restricted to be strings beginning with MR followed by digits.

The logic variable % t is to used to bind the MediaTimePoint in this MediaTime interval % x during logic computation. TRAJECTORY operator is used to assert trajectory region from a moving region % movingregion at MediaTimePoint % t, and OVERLAP is a spatial logic operator for further asserting that the desired object region is also overlapped with the focus area.

A form of logic, called Path Predicate Calculus, is defined below. It is embedded within the present multimedia document query language, mmdocQuery in accordance with the invention. Formulas in path predicate calculus are restricted forms of first-order predicate. For these logic-based queries and manipulations, an embodiment of the present invention comprises two important predicates: element predicates and path predicates, for asserting logical truth statements about document elements in a document tree. In the following, we will first describe all allowable formulas in this logic by recursively defining well-formed formulas and then show several examples of XML modification manipulations specified in this formalism.

Formulas in path predicate calculus are of the form P (x1, x2, . . . , xn, c1, c2, . . . , cm, t1, t2, . . . tp, a1, . . . , aq, d1, . . . , dr) where x1, x2, . . . , xn, c1, c2, . . . , cm, t1, t2, tp, a1, . . . , aq, d1, . . . , dr are free logic variables for representing element attributes, element contents, tag names, element addresses, and element datatype members respectively. An occurrence of a variable in a formula is “free” if that variable has not been introduced by a “for all” or “there exists” quantifier. Otherwise, it is a “bound” variable. Queries in this logic formalism are equivalent to finding all proofs to existential closure of P(x1, x2, . . . , xn, c1,c2, . . . , cm, t1, t2, . . . , tp, a1, . . . ,aq, d1, . . . ,dr), i.e., to (EX x1) (EXx2) ( . . . ) (EX dr) P(x1, x2, . . . ,xn, c1,c2, . . . ,cm, t1, t2, . . . , tp, a1, . . . , aq, d1, . . . ,dr). The detailed descriptions about relationships between logic computation and specification can be seen [11].

The atomic formula is in any of the forms:

1. E(x1, x2, . . . , xn, c, t, a), where E is an element predicate and each of x1, x2, . . . , xn, c, t, a is a constant or variable. The predicate E(x1, x2, . . . , xn, c, t, a) stands for a logic assertion that element “t” at address “a” contains “c” with attributes x1, x2, . . . , xn in a document tree.

An English-like notation for element predicate is (<% t>WITH attribute_l=x1, . . . , attribute_n=% oxn AT % a CONTAINING % c). For brevity, we can also use short versions with only needed variables in logic queries such as (<% t>WITH attribute_{—}1=% x 1, . . . attribute_n=% x n), (<% t>CONTAINING % c), etc., if a full version can be implied clearly in the context.

2. mm-operator (x1, x2, x3, . . . , xn), where x1, . . . , xn are constants, element address variables or element datatype variables. An mm-operator(x1, x2, x3, . . . , xn) asserts logic predicates about spatial, temporal, or visual relationships of document segments based on abstract datatypes in XML Schema framework. See Extensible Markup Language (XML) 1.0 (Second Edition), W3C Recommendations 6 Oct. 2000. The multimedia object descriptions can be specified as XML elements with spatial, temporal or visual datatypes. Based on abstract datatypes, many spatial, temporal and visual mm-operators such as area-overlap, inside, nearby, time-before, time-after, color-similarity, etc., can be defined for specifying intensional multimedia object relationships in XML documents.

3. x op y, where op is an arithmetic comparison operator and x, y are either constants, element attribute variables, or element datatype variables.

4. TYPEP(x tn) where x is a constant or variable and tn is a element datatype name for asserting logic truth about an element datatype.

5. MEMBERP(d tv) where d is a constant or variable, and tv is an element address variable or an element with a datatype for asserting logic truth about member d in tv with this datatype. For example, MEMBERP(2, <LIST>1 2 3 4</LIST>) will be true if this instance of LIST element is defined with list-of-integers datatype in a document.

All other allowable logic formulas are recursively defined from atomic ones.

1 (Boolean formula) If P1 and P2 are well-formed formulas in path predicate calculus, then P1 AND P2, P1 OR P2, and NOT P1 are all well-formed formulas for asserting “P1 and P2 are both true”, “P1 or P2 or both are true” and “P1 is not true” respectively.

2 (Path Predicate) If both P1 and P2 are well-formed formulas having at least one element predicate then (P1 “axis-op” P2) is also a well-formed formula for asserting logic truths P1 with path constraint P2 about document elements in a document tree. The “axis-op” is one of W3C XPath axis operators. Examples are (a) parent/child relationship operators such as: INSIDE, DIRECTLY INSIDE, CONTAINING, DIRECTLY CONTAINING, etc. and (b) the sibling relationship operators such as: BEFORE, IMMEDIATELY BEFORE, AFTER, IMMEDIATELY AFTER, SIBLING, IMMEDIATELY SIBLING, etc. Note that here we illustrate a logic version of axis concepts defined in XPath since path formula in Path Predicate Calculus are logical statements for asserting logical truths. An example of the path predicate is: <(<bibrep INSIDE (<paper>CONTAINING (<fname>CONTAINING “Peiya”) AND (<surname>CONTAINING “Liu”>))) for specifying all bibref elements inside Peiya Liu's paper.

3 (Quantifiedf ormula): If P is a formula, then (EXx)(P) is also a formula. The symbol EX is a quantifier read “there exists”. The occurrences of x that is free in P are bound to (EXx)(P). The formula (EXx)(P) asserts that there exists a value of x such that when we substitute this value for all free occurrences of x in P, the formula P becomes true. The only other quantifier is ALL can be defined in a similar way. If P is a formula, then (ALL x)(P) is also a formula. The symbol ALL is a quantifier read “for all”. The occurrences of x that are free in P are bound to (ALL x)(P). The formula (ALL x)(P) asserts that all possible values of x such that when we substitute any such a value for all free occurrences of x in P, the formula P becomes true.

Note that domains of variables in P are finite in this path predicate calculus since in a particular document instance for being queried, there are finite numbers of element attributes, element contents, tag names, element datatypes and element addresses. This “safe” property is required to avoid finding all proofs of query formula over infinite domains. In a real query language design, we can further restrict variables by using regular expressions for allowable variable patterns shown previously.

Considering now a structured content query, MPEG-7 XML documents can organize multimedia content in a more structured manner to support better visual information retrievals beyond feature-based content retrievals. To benefit this, XML query language constructs need to have very expressive power about document structure and addressing specifications. In the following example, a more complex MPEG-7 structured content query is given to illustrate document addressing specifications in this logic formalism.

| | |
|---|---|
| GENERATE | <List> |

<Videoobject>%objectid</videoobject>
<ShowUpTime>%t</ShowUpTime>

| | |
|---|---|
| | </List> |
| PATTERN | {“MR”[0-9][0-9][0-9]/%objectid} |
| | {<region> ...</region>/%focusarea} |
| | {*“Scence”/%scence} |
| FROM | mpeg7video.xml |
| CONTEXT | ((<Segment> WITH xsi:type=“MovingRegionType” |

id=%objectid AT %movingregion )

INSIDE

((<Segment> WITH xsi:type=“MovingRegionType”

id=%scence)

IMMEDIATELY SIBLING
(<Segment> WITH xsi:type=“MovingRegionType”

id=“BurnerScence”)))

CONTAINING
(<SpatioTemporalLocator> DIRECTLY CONTAINING

(<MediaTime> AT %x)))

AND MEMBERP(%t %x)
AND OVERLAP(TRAJECTORY(%movingregion %t) %focusarea))

In the present query, we add more constraints in CONTEXT clause in the form of find out only those objects in the focus area, but shown up in a scene which appears either immediately before or after Burner scene. This query requires an expressive power for specifying the contexts of objects by a path formula about addressing constraints about parent/ancestor/child and sibling relationships among document elements in this recursive video segment structure.

The invention has been described by way of exemplary embodiments and is best practiced with the application of a programmable digital computer. As will be understood by one of skill in the art to which the present invention pertains, various changes and modifications will be apparent.

Such changes and substitutions which do not depart from the spirit of the invention are contemplated to be within the scope of the invention which is defined by the claims following.

What is claimed is:

1. A query system for structured multimedia content retrieval, said system including:
a query language having query constructs and formalisms for specifying characteristics of extensible markup language (XML) documents for retrieval; and
wherein said characteristics include spatial, temporal, and visual datatypes.

2. A query system as recited in claim 1, wherein said query language includes:
means for resolving intensional data and relationships arising from any of:
(a) XML datatype mechanism;
(b) irregular XML structures; and
(c) co-occurrence constraints.

3. A query system as recited in claim 2, wherein said means for resolving comprises a logic formalism for supporting queries on XML documents with any of:
(A) intensional data and relationships;
(B) irregular document structures; and
(C) and co-occurrence constraints.

4. A query system as recited in claim 1, wherein said query language includes
means for identifying specification issues in XML query language for XML document retrieval.

5. A query system as recited in claim 1, wherein said query language includes
means for identifying specification issues in XML query language for MPEG-7 document retrieval.

6. A query system for structured multimedia content retrieval, said system including:
a query language based on logic formalism for content retrieval; and
said logic formalism including atomic logic formulas, said atomic logic formulas being element predicates in a relational calculus.

7. A query system as recited in claim 6, wherein said query language comprises query constructs and formalisms for specifying different aspects of extensible markup language (XML) documents.

8. A query system as recited in claim 7, wherein said query constructs and formalisms are adapted for spatial, temporal and visual datatypes.

9. A query system as recited in claim 7, wherein said query constructs and formalisms are adapted for spatial, temporal and visual datatypes in MPEG-7 documents.

10. A query system as recited in claim 6, wherein:
queries in said relational calculus are equivalent to a proof-finding process; and
said proof-finding process comprises finding all proofs to existential closure of logical assertions in the form of path predicates required to be satisfied by tree document elements.

11. A query system as recited in claim 7, wherein spatial, temporal and visual datatypes and relationships are described in said logic formalism for content retrieval.

12. A query system as recited in claim 7, wherein said query language includes:
means for resolving intensional data and relationships arising from any of:
(a) XML datatype mechanism;
(b) irregular XML structures; and
(c) co-occurrence constraints.

13. A query system as recited in claim 12, wherein said query language includes
means for identifying specification issues in XML query language for XML document retrieval.

14. A query system as recited in claim 13, wherein said query language includes
means for identifying specification issues in XML query language for MPEG-7 document retrieval.

15. A query system for structured multimedia content retrieval, said system including:
a query language based on logic formalism for content retrieval; and
said logic formalism including atomic logic formulas, said atomic logic formulas being element predicates in a relational calculus.

16. A query system as recited in claim 15, wherein:
queries in said relational calculus are equivalent to a proof-finding process; and
said proof-finding process comprises finding all proofs to existential closure of logical assertions in the form of path predicates required to be satisfied by tree document elements.

17. A query system as recited in claim 15, wherein spatial, temporal and visual datatypes and relationships are described in said logic formalism for content retrieval.

18. A query system as recited in claim 15, wherein said query language includes:
means for resolving intensional data and relationships arising from any of:
(a) XML datatype mechanism;
(b) irregular XML structures; and
(c) co-occurrence constraints.

19. A query system as recited in claim 18, wherein said query language includes means for identifying specification issues in XML query language for XML document retrieval.

20. A query system as recited in claim 19, wherein said query language includes
means for identifying specification issues in XML query language for MPEG-7 document retrieval.

21. A query system for structured multimedia content retrieval, said system including:
a query language based on logic formalism for content retrieval;
said logic formalism including atomic logic formulas, said atomic logic formulas being element predicates in a relational calculus;
means for identifying given specifications of multimedia XML documents in MPEG-7 XML query specifications; and
means for applying said logic formalism for processing said given specifications for specifying spatial and temporal relationships pertaining to said XML documents to support MPEG-7 XML document retrieval and modification of multimedia XML documents.

22. A query system in accordance with claim 21, wherein said given specifications include intensional data and relationships specifications, document addressing specifications, and co-occurrence constraints specifications.

23. A query system in accordance with claim 21, wherein said given specifications include element datatypes.

24. A query system in accordance with claim 23, wherein spatial and temporal relationships are derived from said element datatypes.

25. A query system in accordance with claim 24, wherein spatial and temporal relationships are further included in said given specifications as a complex datatype for multimedia XML documents.

26. A query system in accordance with claim 23, wherein said datatypes.include:
(A) Mpeg7Type, basic datatypes, reference datatypes, unique identifier datatypes, and time datatypes;
(B) MPEG-7 visual datatypes used to specify visual properties of multimedia objects, including spatial, color, texture, motion, location; and
(C) MPEG-7 audio datatypes are used to specify audio content.

27. A query system in accordance with claim 21, including a tool for generating a description from a video based on a scene change technique, said tool including processing means for:
(a) breaking down the video temporally into scenes or shots using scene change detection algorithms that can detect both abrupt as well as gradual changes;
(b) outlining user-identified objects of interest within said scenes;
(c) tracking said user-identified objects;
(d) creating a node point where a significant motion change wherein a linear mode is inadequate;
(e) providing the specification of said user-identified objects as any of temporal, audio, and visual datatypes; and
(f) providing a description of said user-defined objects as any of spatial, temporal and visual datatypes.

28. A query system in accordance with claim 27, wherein processing means provides said tracking said user-identified objects in a semi-automatic manner.

29. A query system in accordance with claim 27, wherein processing means provides said description of said user-defined objects said by the use of abstract datatype techniques (ADT).

30. A query system in accordance with claim 27, wherein processing means provides said respective datatypes as composite datatypes constructed from more primitive ones.

31. A query system for multimedia content retrieval, said system including:
a query language based on logic formalism for content retrieval, said logic formalism being hereinafter referred to as Path Predicate Calculus and being utilized for logic-based queries and manipulations;
said Path Predicate Calculus including atomic logic formulas, said atomic logic formulas being element predicates in a relational calculus and comprising element predicates and path predicates, for asserting logical truth statements about document elements in a document tree;
means for identifying given specifications of multimedia XML documents in MPEG-7 XML query specifications; and
means for applying said logic formalism for processing said given specifications for specifying spatial and temporal relationships pertaining to said XML documents to support MPEG-7 XML document retrieval and modification. multimedia XML documents.

32. A query system as recited in claim 31, wherein:
queries in said relational calculus are equivalent to a proof-finding process; and
said proof-finding process comprises finding all proofs to existential closure of logical assertions in the form of path predicates required to be satisfied by tree document elements.

33. A query system as recited in claim 31, wherein spatial, temporal and visual datatypes and relationships are described in said logic formalism for content retrieval.

34. A query system as recited in claim 31, wherein said query language includes:
means for resolving intensional data and relationships arising from any of:
(a) XML datatype mechanism;
(b) irregular XML structures; and
(c) co-occurrence constraints.

35. A query system as recited in claim 34, wherein said query language includes
means for identifying specification issues in XML query language for XML document retrieval.

36. A query system for structured multimedia content retrieval, said system including:
a query language based on logic formalism for content retrieval, said language including query constructs and formalisms for specifying different aspects of XML documents; and
wherein said constructs and formalisms are particularly adapted for spatial, temporal and visual datatypes.

37. A query system as recited in claim 36, wherein said query language identifies intensional data and relationships due to XML datatype mechanisms, irregular XML structures, and co-occurrence constraints for document retrieval.

38. A query system as recited in claim 37, wherein said query language is specially adapted for MPEG-7 documents.

39. A method for for structured multimedia content retrieval, said method comprising:
utilizing a query language based on logic formalism for content retrieval, said logic formalism including atomic logic formulas, said atomic logic formulas being element predicates in a relational calculus;
identifying given specifications of multimedia XML documents in MPEG-7 XML query specifications; and
applying said logic formalism for processing said given specifications for specifying spatial and temporal relationships pertaining to said XML documents to support MPEG-7 XML document retrieval and modification of multimedia XML documents.

40. A method as recited in claim 39, comprising:
generating a description from a video based on a scene change technique, said generating including the steps of:
(a) breaking down the video temporally into scenes or shots using scene change detection algorithms that can detect both abrupt as well as gradual changes;
(b) outlining user-identified objects of interest within said scenes;
(c) tracking said user-identified objects;
(d) creating a node point where a significant motion change wherein a linear mode is inadequate;
(e) providing the specification of said user-identified objects as any of temporal, audio, and visual datatypes; and
(f) providing a description of said user-defined objects as any of spatial, temporal and visual datatypes.
